(19) United States
(12) Patent Application Publication
(10) Pub. No.: US 2019/0022996 A1
(43) Pub. Date: Jan. 24, 2019

(54) PRINTING PRESS

(71) Applicant: KOMORI CORPORATION, Tokyo (JP)

(72) Inventor: Makoto SATO, Ibaraki (JP)

(21) Appl. No.: 16/070,772

(22) PCT Filed: Jan. 18, 2017
(86) PCT No.: PCT/JP2017/001514

§ 371 Date: Jul. 17, 2018

(30) Foreign Application Priority Data
Jan. 18, 2016 (JP) 2016-006837

(51) Int. Cl. B41F 11/02; B41F 7/02; B41F 9/02; B41F 33/00; B41M 3/14

(52) U.S. Cl. CPC B41F 11/02; B41F 7/02; B41M 3/14; B41F 33/0036; B41F 9/021

(57) ABSTRACT

A printing press (1) includes an obverse printing unit (12) configured to perform printing on an obverse surface of a sheet (3), a reverse printing unit (13) configured to perform printing on a reverse surface of the sheet (3), and an upstream-side obverse checking unit (41) configured to irradiate the obverse surface of the sheet (3) with visible light and performs a check based on reflected light and also perform a check different from the check using the visible light. It is therefore possible to execute a plurality of types of checks without using a dedicated checking machine other than the printing press (1).

### TECHNICAL FIELD

The present invention relates to a printing press that prints a paper money, securities, or the like.

### BACKGROUND ART

Printing presses for printing a paper money, securities, or the like conventionally include printing presses having a function of printing both surfaces of a sheet (paper) and a function of checking a sheet after printing, as disclosed in, for example, patent literatures 1 to 3.

A printing press disclosed in patent literature 1 employs an arrangement that checks printing quality by a delivery unit to which a sheet after printing is fed. The sheet after printing is fed from a printing unit to the delivery unit by a conveyance device including delivery chains. The check of printing quality is performed by an obverse checking device facing the obverse surface of the sheet and a reverse checking device facing the reverse surface of the sheet.

A printing press disclosed in patent literature 2 includes a printing unit formed by a plurality of cylinders arranged in a so-called satellite-type cylinder arrangement. In this printing press, the check of printing quality is performed using an obverse surface checking camera and a reverse surface checking camera which are arranged near the printing unit. The obverse surface checking camera is provided at a position facing a transfer cylinder that receives a sheet after printing from the blanket impression cylinder of the printing unit. The sheet is transferred from the transfer cylinder to the delivery cylinder of a conveyance device including delivery chains and fed by the conveyance device to a delivery unit. The reverse surface checking camera is provided at a position facing the delivery cylinder. Each of the obverse surface checking camera and the reverse surface checking camera is formed using an optical/electronic image capturing device such as a CCD line camera or a CCD line sensor. For this reason, in the printing press shown in patent literature 2, a check using visible light is performed.

A printing press disclosed in patent literature 3 includes a Sammeldruck printing unit that performs Sammeldruck printing on the obverse surface of a sheet, and an offset printing unit that performs offset printing on both the obverse and reverse surfaces of the sheet. The sheet is fed from the Sammeldruck printing unit to the offset printing unit and then delivered to a delivery unit. The offset printing unit includes a plurality of printing units that perform printing on the obverse surface of the sheet and a plurality of printing units that perform printing on the reverse surface of the sheet. In this printing press, the check of printing quality is performed by an obverse surface checking camera and a reverse surface checking camera which are arranged at the downstream end of the offset printing unit in the sheet conveyance direction.

A recent printing press for printing a paper money, securities, or the like performs elaborate and complex printing to more effectively prevent forgery. Hence, when checking printing quality in the printing press, more types of checks are required to be performed to correctly discriminate the quality of elaborate and complex printing.

In the printing press disclosed in patent literature 1, since the check is performed for the sheet conveyed by the conveyance device using the delivery chains, the sheet may be misregistered, and a check failure may occur. On the other hand, in the printing press disclosed in patent literature 2 or 3, since printing quality is checked before chain conveyance is performed, a failure as in the printing press of patent literature 1 hardly occurs. However, even in such a printing press, there is a limit in increasing check items because only one type of check is performed. In the printing presses shown in patent literatures 1 to 3, to increase the types of checks, a dedicated checking machine different from the printing press needs to be used.

### RELATED ART LITERATURE

### Patent Literature

Patent Literature 1: Japanese Patent Laid-Open No. 2012-81770

Patent Literature 2: Japanese Patent Laid-Open No. 2014-8754

Patent Literature 3: Japanese Patent Laid-Open No. 2013-59925

### DISCLOSURE OF INVENTION

### Problem to be Solved by the Invention

The present invention has been made to solve the above-described problems, and has as its object to provide a printing press capable of executing a plurality of types of checks without using a dedicated checking machine different from the printing press.

### Means of Solution to the Problem

In order to achieve the above-described object, according to the present invention, there is provided a printing press comprising a first printing unit configured to perform printing on an obverse surface of a sheet, a second printing unit configured to perform printing on a reverse surface of the sheet, a first checking unit configured to irradiate one of the obverse surface and the reverse surface of the sheet with visible light and perform a check based on reflected light, and a second checking unit configured to perform a check different from the check using the visible light for a surface, checked by the first checking unit, of the sheet.

### Effect of the Invention

In the present invention, an obverse surface or a reverse surface of a sheet can be checked by two types of checks including a check using visible light by a first checking unit and a check by a second checking unit which is different from the check using the visible light. Hence, according to the present invention, it is possible to provide a printing press capable of executing a plurality of types of checks without using a dedicated checking machine.

### BRIEF DESCRIPTION OF DRAWINGS

FIG. 1 is a side view showing the arrangement of a printing press according to the first embodiment;

FIG. 2 is a side view showing the arrangement of an upstream-side obverse checking unit;

FIG. 3 is a front view showing the arrangement of the upstream-side obverse checking unit;

FIG. 4 is a side view showing the arrangement of a downstream-side obverse checking unit;

FIG. 5 is a front view showing the arrangement of the downstream-side obverse checking unit;

FIG. 6 is a block diagram showing the arrangement of a checking unit;

FIG. 7 is a side view showing the arrangement of a printing press according to the second embodiment;

FIG. 8 is an enlarged side view showing a part of a printing unit and an upstream-side checking unit; and

FIG. 9 is an enlarged side view showing a part of a sheet delivery unit and a downstream-side checking unit.

### BEST MODE FOR CARRYING OUT THE INVENTION

### First Embodiment

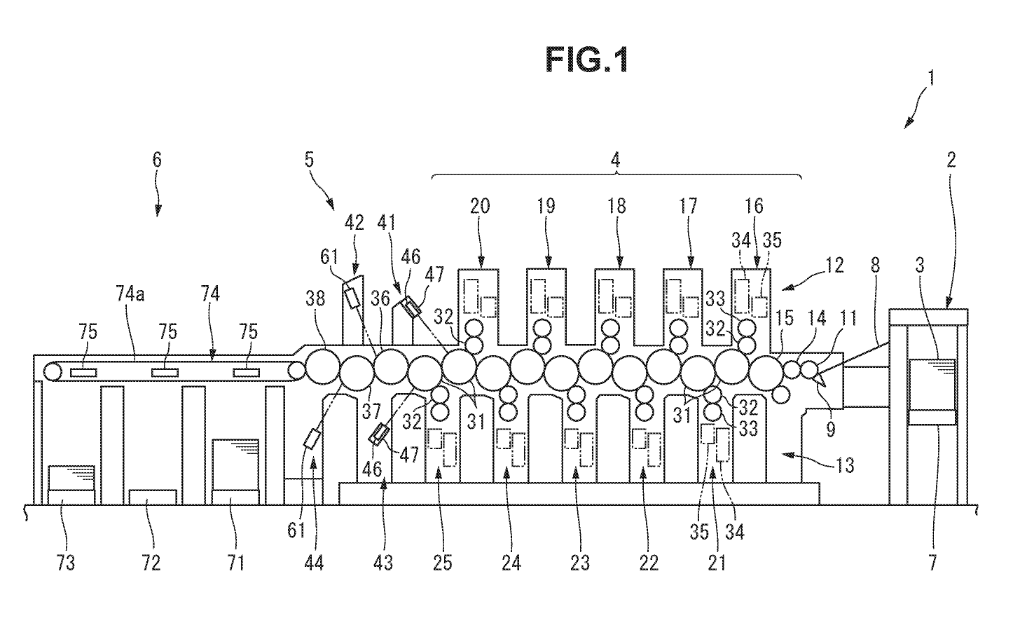

A printing press according to an embodiment of the present invention will now be described in detail with reference to FIGS. 1 to 6.

A printing press 1 shown in FIG. 1 is an offset printing press used to print a paper money, securities, bank notes, passports, and other similar documents. The printing press 1 includes a sheet supply unit 2 located at the right-side end in FIG. 1, an offset printing unit 4 that performs printing on both the obverse and reverse surfaces of a sheet 3, a checking unit 5 that checks printing quality, and a sheet delivery unit 6 configured to deliver the sheet 3.

The sheet supply unit 2 includes a vertically movable feeder pile 7 on which a number of sheets 3 are stacked, and a sucker device (not shown) that places the sheet 3 located uppermost on a feeder board 8. The sheet 3 placed on the feeder board 8 is transferred to a first transfer cylinder 11 of the offset printing unit 4 by a swing device 9.

The offset printing unit 4 includes an obverse printing unit 12 configured to perform printing on the obverse surface of the sheet 3, a reverse printing unit 13 configured to perform printing on the reverse surface of the sheet 3, and first to third transfer cylinders 11, 14, and 15 configured to supply the sheet 3 to the obverse printing unit 12. In this embodiment, the obverse printing unit 12 corresponds to “first printing unit” of the present invention, and the reverse printing unit 13 corresponds to “second printing unit” of the present invention.

The obverse printing unit 12 is formed by first to fifth obverse printing units 16 to 20 arranged in the sheet conveyance direction. The reverse printing unit 13 is formed by first to fifth reverse printing units 21 to 25 arranged in the sheet conveyance direction. Each of the printing units 16 to 25 of the obverse printing unit 12 and the reverse printing unit 13 includes an impression cylinder 31, a blanket cylinder 32, a plate cylinder 33, an inking device 34, a dampener 35, and the like.

Each of the impression cylinder 31 and the above-described first to third transfer cylinders 11, 14, and 15 includes a gripper device (not shown) that grips and holds the end of the sheet 3 on the downstream side in the conveyance direction. The sheet 3 is fed from the above-described third transfer cylinder 15 to the impression cylinder 31 of the first obverse printing unit 16. The impression cylinders 31 in the obverse printing unit 12 and the impression cylinders 31 in the reverse printing unit 13 are arranged in the horizontal direction in a state in which the sheet 3 can be transferred. In addition, the impression cylinders 31 of the first to fourth reverse printing units 21 to 24 are located between the impression cylinders 31 of the first to fifth obverse printing units 16 to 20. The impression cylinder 31 of the fifth reverse printing unit 25 is arranged between the impression cylinder 31 of the fifth obverse printing unit 20 and a fourth transfer cylinder 36 to be described later.

The fourth to sixth transfer cylinders 36 to 38 are arranged between the offset printing unit 4 and the sheet delivery unit 6 to be described later in a state in which the transfer cylinders are arranged in the horizontal direction.

Each of the fourth to sixth transfer cylinders 36 to 38 includes a gripper device (not shown) that holds the end of the sheet 3 on the downstream side in the conveyance direction, and conveys the sheet 3 printed by the offset printing unit 4 to the sheet delivery unit 6.

The blanket cylinder 32 is configured to be contactable with the impression cylinder 31, and ink on the plate cylinder 33 is transferred to the blanket cylinder 32. The ink transferred to the blanket cylinder 32 is transferred to the sheet 3 when the sheet 3 passes between the blanket cylinder 32 and the impression cylinder 31. To the plate cylinder 33, the ink is supplied from the inking device 34, and simultaneously, dampening water is supplied from the dampener 35.

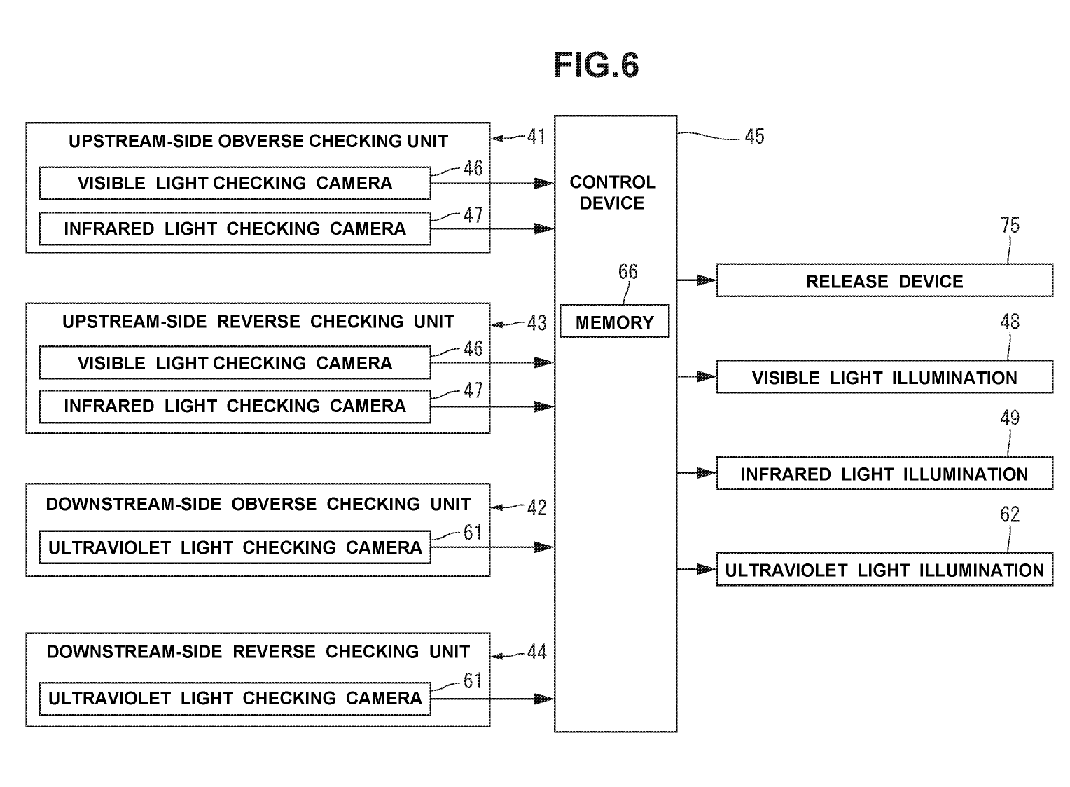

The checking unit 5 includes an upstream-side obverse checking unit 41 and a downstream-side obverse checking unit 42, which check printing quality of the obverse surface of the sheet 3, an upstream-side reverse checking unit 43 and a downstream-side reverse checking unit 44, which check printing quality of the reverse surface of the sheet 3, and a control device 45 (see FIG. 6) connected to the checking units 41 to 44.

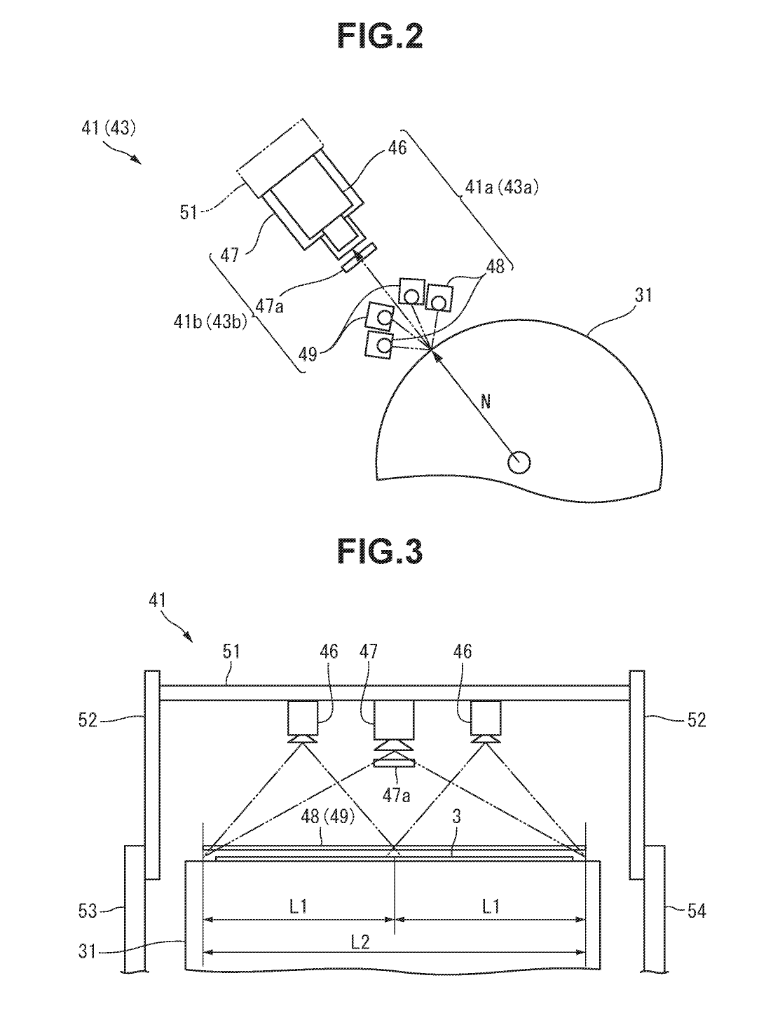

As shown in FIGS. 2 and 3, the upstream-side obverse checking unit 41 includes two visible light checking cameras 46 and one infrared light checking camera 47, which direct obliquely from the upper side to the impression cylinder 31 of the fifth obverse printing unit 20, and visible light illuminations 48 and infrared light illuminations 49. The two visible light checking cameras 46 and the visible light illuminations 48 form a visible light obverse checking unit 41a that irradiates the obverse surface of the sheet 3 with visible light and performs a check based on reflected light. In addition, the infrared light checking camera 47 and the infrared light illuminations 49 form an infrared light obverse checking unit 41b that irradiates the obverse surface of the sheet 3 with infrared light and performs a check based on reflected light. In this embodiment, the visible light obverse checking unit 41a corresponds to “first checking unit” of the present invention, and the infrared light obverse checking unit 41b corresponds to “second checking unit” of the present invention.

As shown in FIG. 1, the position to which the visible light checking cameras 46 and the infrared light checking camera 47 direct is a position on the impression cylinder 31 of the fifth obverse printing unit 20 on the downstream side in the sheet conveyance direction with respect to the position of contact with the blanket cylinder 32 and on the upstream side in the sheet conveyance direction with respect to the position of contact with the impression cylinder 31 of the fifth reverse printing unit 25. The optical axes of the cameras 46 and 47 preferably match a normal direction N passing through the outer peripheral surface of the impression cylinder 31 when viewed from the axial direction of the impression cylinder 31, as shown in FIG. 2. When the cameras 46 and 47 are arranged in this way, an image of the obverse surface of the sheet 3 viewed from a direction perpendicular to the obverse surface can be acquired. The visible light checking camera 46 sends visible light that has entered the control device 45 as image data. The infrared light checking camera 47 sends infrared light that has entered the control device 45 as image data.

As shown in FIG. 3, the two visible light checking cameras 46 and the infrared light checking camera 47 are arranged in the axial direction (the left-to-right direction in FIG. 3) of the impression cylinder 31. The infrared light checking camera 47 is arranged between the two visible light checking cameras 46 at a position not to be captured by the visible light checking cameras 46. The visual field of each visible light checking camera 46 is narrower than the visual field of the infrared light checking camera 47, as indicated by alternate long and two short dashed lines in FIG. 3. A checking width L1 of the visible light checking camera 46 is about ½ of a checking width L2 of the infrared light checking camera 47 in a state in which all the cameras 46 and 47 are located apart from the impression cylinder 31 by equal distances. The infrared light checking camera 47 includes a filter 47a that passes only infrared light.

The three cameras 46 and 47 are attached to a support member 51 extending in the axial direction of the impression cylinder 31. The two ends of the support member 51 are supported by first and second frames 53 and 54 via a pair of columns 52 extending in the vertical direction. The first and second frames 53 and 54 rotatably support the two ends of the impression cylinder 31. The distances between the impression cylinder 31 and the visible light checking cameras 46 and the infrared light checking camera 47 are determined based in the areas of the visual fields of the cameras 46 and 47, as shown in FIG. 3. The visible light checking cameras 46 are arranged at positions at which the checking width (L1×2) of the two camera is longer than the width (the length in the axial direction of the impression cylinder 31) of the sheet 3. The infrared light checking camera 47 is arranged at a position at which the checking width L2 is longer than the width of the sheet 3.

As the visible light illumination 48, an illumination including, for example, a white LED as a light source can be used. In this embodiment, two visible light illuminations 48 are arranged at positions sandwiching the optical axes of the visible light checking cameras 46 from both sides in the vertical direction, as shown in FIG. 2, and are supported by the above-described support member 51 or columns 52 via support stays (not shown). Visible light emitted by the visible light illuminations 48 is reflected by the obverse surface of the sheet 3 and enters the visible light checking cameras 46.

As the infrared light illumination 49, an illumination including, for example, an infrared LED as a light source can be used. In this embodiment, two infrared light illuminations 49 are arranged at positions sandwiching the optical axis of the infrared light checking camera 47 from both sides in the vertical direction, and are supported by the support member 51 or the columns 52 via the above-described support stays together with the visible light illuminations 48. Infrared light emitted by the infrared light illuminations 49 is reflected by the obverse surface of the sheet 3 and enters the infrared light checking camera 47.

The upstream-side reverse checking unit 43 employs the same arrangement as the upstream-side obverse checking unit 41 except that the position of the checking target is different. The two visible light checking cameras 46 and the visible light illuminations 48 form a visible light reverse checking unit 43a that irradiates the reverse surface of the sheet 3 with visible light and performs a check based on reflected light. In addition, the infrared light checking camera 47 and the infrared light illuminations 49 form an infrared light reverse checking unit 43b that irradiates the reverse surface of the sheet 3 with infrared light and performs a check based on reflected light. In this embodiment, the visible light reverse checking unit 43a corresponds to “third checking unit” of the present invention, and the infrared light reverse checking unit 43b corresponds to “fourth checking unit” of the present invention.

The two visible light checking cameras 46 of the upstream-side reverse checking unit 43 and the one infrared light checking camera 47 located between the visible light checking cameras 46 direct to the impression cylinder 31 of the fifth reverse printing unit 25, as shown in FIG. 1. More specifically, the cameras 46 and 47 direct obliquely from the lower side to a position on the impression cylinder 31 on the downstream side in the sheet conveyance direction with respect to the position of contact with the blanket cylinder 32 of the fifth reverse printing unit 25 and on the upstream side in the sheet conveyance direction with respect to the position of contact with the fourth transfer cylinder 36. In addition, the three cameras 46 and 47 of the upstream-side reverse checking unit 43 are attached to a lower support member (not shown) bridged between the first and second frames 53 and 54. The visible light illuminations 48 and the infrared light illuminations 49 of the upstream-side reverse checking unit 43 are supported by the lower support member or the first and second frames 53 and 54 via support stays (not shown).

As shown in FIGS. 1, 4, and 5, the downstream-side obverse checking unit 42 includes an ultraviolet light checking camera 61 and ultraviolet light illuminations 62, which direct obliquely from the upper side to the fourth transfer cylinder 36, and a shielding member 63. The ultraviolet light checking camera 61 sends ultraviolet light that has entered the control device 45 as image data. In this embodiment, the downstream-side obverse checking unit 42 corresponds to “fifth checking unit” of the present invention.

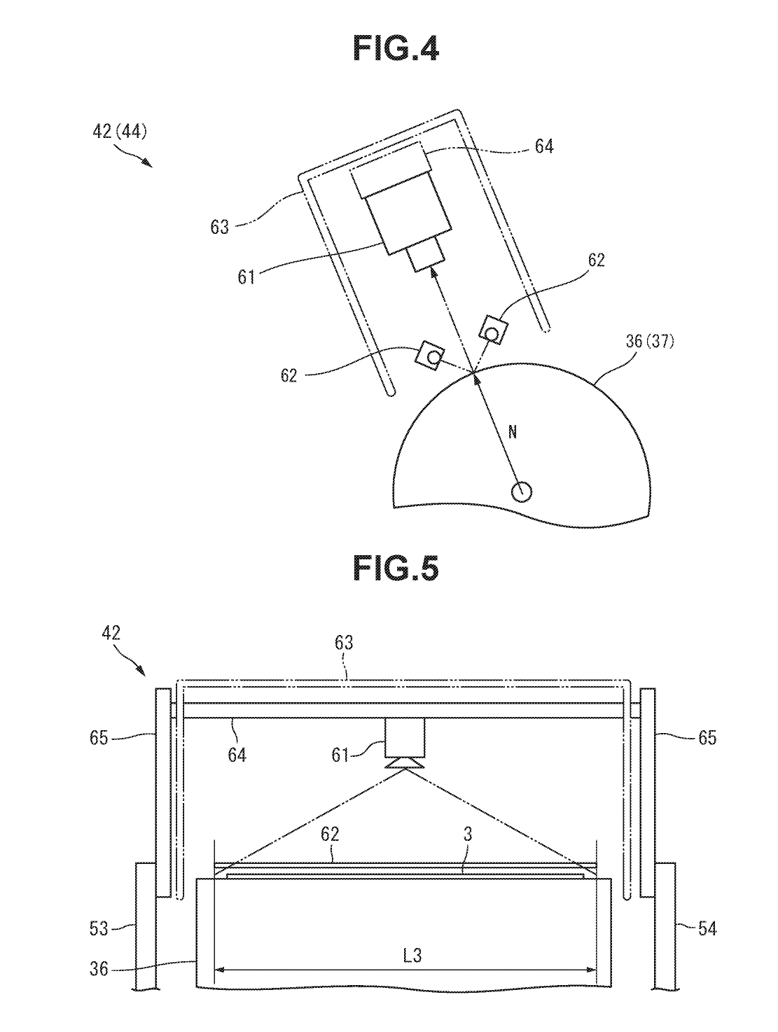

As shown in FIG. 1, the position to which the ultraviolet light checking camera 61 of the downstream-side obverse checking unit 42 directs is a position on the fourth transfer cylinder 36 on the downstream side in the sheet conveyance direction with respect to the position of contact with the impression cylinder 31 of the fifth reverse printing unit 25 and on the upstream side in the sheet conveyance direction with respect to the position of contact with the fifth transfer cylinder 37. The optical axis of the camera 61 preferably matches the normal direction N passing through the outer peripheral surface of the fourth transfer cylinder 36 when viewed from the axial direction of the fourth transfer cylinder 36, as shown in FIG. 4. When the ultraviolet light checking camera 61 is arranged in this way, an image of the obverse surface of the sheet 3 viewed from a direction perpendicular to the obverse surface can be acquired.

As shown in FIG. 5, the ultraviolet light checking camera 61 is located at a position facing the center of the fourth transfer cylinder 36 in the axial direction and attached to a support member 64 extending in the axial direction of the fourth transfer cylinder 36. The two ends of the support member 64 are supported by the first and second frames 53 and 54 via a pair of columns 65 extending in the vertical direction. The distance between the ultraviolet light checking camera 61 and the fourth transfer cylinder 36 is determined based in the area of the visual field of the ultraviolet light checking camera 61, as shown in FIG. 5. In this embodiment, the ultraviolet light checking camera 61 is arranged at a position at which a checking width L3 of the ultraviolet light checking camera 61 is longer than the width (the length in the axial direction of the fourth transfer cylinder 36) of the sheet 3.

As the ultraviolet light illumination 62, an illumination including, for example, an ultraviolet LED as a light source can be used. In this embodiment, two ultraviolet light illuminations 62 are arranged at positions sandwiching the optical axis of the ultraviolet light checking camera 61 from both sides in the vertical direction, as shown in FIG. 4, and are supported by the above-described support member 64 or columns 65 via support stays (not shown). Ultraviolet light emitted by the ultraviolet light illuminations 62 is reflected by the obverse surface of the sheet 3 and enters the ultraviolet light checking camera 61.

The shielding member 63 is used to limit the reachable range of ultraviolet light generated by the ultraviolet light illuminations 62, and is formed into a box shape opening only to the outer peripheral surface of the fourth transfer cylinder 36. The shielding member 63 can be fixed to the support member 64 together with the ultraviolet light checking camera 61.

The downstream-side reverse checking unit 44 employs the same arrangement as the downstream-side obverse checking unit 42 except that the position of the checking target is different. In this embodiment, the downstream-side reverse checking unit 44 corresponds to “sixth checking unit” of the present invention.

The ultraviolet light checking camera 61 of the downstream-side reverse checking unit 44 directs to the fifth transfer cylinder 37, as shown in FIG. 1. More specifically, the camera 61 directs obliquely from the lower side to a position on the fifth transfer cylinder 37 on the downstream side in the sheet conveyance direction with respect to the position of contact with the fourth transfer cylinder 36 and on the upstream side in the sheet conveyance direction with respect to the position of contact with the sixth transfer cylinder 38. In addition, the ultraviolet light checking camera 61 of the downstream-side reverse checking unit 44 is attached to the lower support member (not shown) bridged between the first and second frames 53 and 54. The ultraviolet light illuminations 62 of the downstream-side reverse checking unit 44 are supported by the lower support member or the first and second frames 53 and 54 via support stays (not shown).

The control device 45 to which image data is sent from the above-described cameras 46, 47, and 61 has the following three functions. The first function is a function of controlling the operations of the checking units 41 to 44 including the times of image capturing by the cameras 46, 47 and 61. The second function is a function of determining printing quality by performing image processing. The quality determination is done by comparing actual image data sent from the cameras 46, 47, and 61 with determination image data recorded in a memory 66 (see FIG. 6) in advance. The third function is a function of switching the delivery destination of the sheet 3 based on the quality determination result. The delivery destination of the sheet 3 includes a plurality of delivery piles 71 to 73 (see FIG. 1) provided in the sheet delivery unit 6 to be described later.

As shown in FIG. 1, the sheet delivery unit 6 includes a chain-type conveyance device 74 adjacent to the sixth transfer cylinder 38, and the first to third delivery piles 71 to 73. The conveyance device 74 includes, a pair of delivery chains 74a arranged in the axial direction of the sixth transfer cylinder 38, a number of gripper bars (not shown) bridged between the delivery chains 74a, gripper devices (not shown) provided on the gripper bars, and the like. The delivery chains 74a are arranged between the sixth transfer cylinder 38 and the upper portions of the delivery piles 71 to 73.

Each gripper device in the conveyance device 74 is configured to be able to switch between a holding state in which the end of the sheet 3 on the downstream side in the conveyance direction is held and a release state in which the sheet 3 is released. In a state in which the sheet 3 is received from the sixth transfer cylinder 38, the gripper device moves to the upper side of the delivery piles 71 to 73 in accordance with the rotation of the delivery chains 74a. A release device 75 configured to selectively set the gripper device in the release state is provided on the upper side of each of the first to third delivery piles 71 to 73. The operations of the release devices 75 are controlled by the control device 45.

Each of the release devices 75 located above the first and second delivery piles 71 and 72 sets the gripper device in the release state when the sheet 3 determined as a non-defective product by the above-described quality determination passes. In addition, when the sheet 3 determined as a defective product passes, the release device 75 takes a form in which the sheet passes in the holding state of the gripper device. The release device 75 located above the third delivery pile 73 sets the gripper device in the release state when the sheet 3 determined as a defective product by the above-described quality determination passes and otherwise, takes a form in which the sheet passes in the holding state of the gripper device. For this reason, the sheets 3 determined as non-defective products by the quality determination are stacked on the first and second delivery piles 71 and 72, and the sheets 3 determined as defective products are stacked on the third delivery pile 73.

In the thus configured printing press 1, the sheet 3 is fed from the sheet supply unit 2 to the offset printing unit 4, and the offset printing unit 4 performs printing on both surfaces of the sheet 3. The sheet 3 after printing undergoes a printing quality check by the checking unit 5. The printing quality of the obverse surface of the sheet 3 is checked by the upstream-side obverse checking unit 41 and the downstream-side obverse checking unit 42. On the other hand, the printing quality of the reverse surface of the sheet 3 after printing is checked by the upstream-side reverse checking unit 43 and the downstream-side reverse checking unit 44. These checks are executed by the control device 45 using image data obtained by image capturing of the cameras of the checking units. The sheet 3 of the check target is determined to one of a non-defective product and a defective product by the check. The thus checked sheet 3 is delivered to one of the first to third delivery piles 71 to 73 in the sheet delivery unit 6 based on the check result.

In the printing press 1, the printing quality of the obverse surface of the sheet 3 can be checked by two types of checks, that is, a check (a check using visible light) by the visible light obverse checking unit 41a (first checking unit) including the visible light checking cameras 46 and the visible light illuminations 48 in the upstream-side obverse checking unit 41 and a check (a check that is different from the check using visible light and uses infrared light) by the infrared light obverse checking unit 41b (second checking unit) including the infrared light checking camera 47 and the infrared light illuminations 49. Additionally, in the printing press 1, the printing quality of the obverse surface and the reverse surfaces of the sheet 3 can be checked by two types of checks, that is, a check using visible light by the visible light obverse checking unit 41a (first checking unit) including the visible light checking cameras 46 and the visible light illuminations 48 of the upstream-side obverse checking unit 41 and the visible light reverse checking unit 43a (third checking unit) including the visible light checking cameras 46 and the visible light illuminations 48 of the upstream-side reverse checking unit 43, and a check using ultraviolet light by the downstream-side obverse checking unit 42 (fifth checking unit) and the downstream-side reverse checking unit 44 (sixth checking unit). Hence, according to this embodiment, it is possible to provide a printing press capable of executing a plurality of types of checks without using a dedicated checking machine.

The visible light (visible) check performed using the visible light checking cameras 46 in the upstream-side obverse checking unit 41 and the upstream-side reverse checking unit 43 has a high checking accuracy and can check a more precise image. On the other hand, the ultraviolet light (UV) check performed using the ultraviolet light checking camera 61 has a lower checking accuracy as compared to the above check, and cannot check a more precise image as in the visible light check.

In the printing press 1 in which printing is performed by the offset printing unit 4, when printing the sheet 3, the sheet 3 is sandwiched between the impression cylinder 31 and the blanket cylinder 32, and a printing pressure is applied to the sheet 3. When the printing pressure is applied to the sheet 3, the sheet 3 is slightly stretched, and the printed pattern slightly changes. For this reason, the visible light check of the high checking accuracy is preferably performed in a state immediately after printing in which the stretching of the sheet 3 is minimum. In this embodiment, an arrangement is employed in which immediately after final printing of the obverse surface is performed by the fifth obverse printing unit 20, the sheet 3 is captured by the visible light checking cameras 46 of the upstream-side obverse checking unit 41 in a state in which the sheet 3 is held on the impression cylinder 31 of the printing unit 20. In addition, an arrangement is employed in which immediately after final printing of the reverse surface is performed by the fifth reverse printing unit 25, the sheet 3 is captured by the visible light checking cameras 46 of the upstream-side reverse checking unit 43 in a state in which the sheet 3 is held on the impression cylinder 31 of the fifth reverse printing unit 25. This enables the visible light check in a state immediately after printing in which the stretching of the sheet 3 is minimum, and the risk of a check failure in the visible light check can be eliminated.

As the check performed in the checking unit 5, the visible light check is preferably performed first, as described above. When the infrared light check performed using infrared light is simultaneously executed on the same axis (on the same impression cylinder 31) as the visible light check, as in this embodiment, the infrared light check can also be executed in a state in which the pattern is not deformed, and the accuracy of the infrared light check also becomes high.

The printing press 1 according to this embodiment includes the visible light reverse checking unit 43a (third checking unit) including the visible light checking cameras 46 and the visible light illuminations 48 in the upstream-side reverse checking unit 43, and the infrared light reverse checking unit 43b (fourth checking unit) including the infrared light checking camera 47 and the infrared light illuminations 49 in addition to the upstream-side obverse checking unit 41. The visible light reverse checking unit 43a irradiates the reverse surface of the sheet 3, which is never checked by the visible light obverse checking unit 41a, with visible light and performs the check based on reflected light. The infrared light reverse checking unit 43b performs the infrared light check (a check different from the visible light check) for the reverse surface of the sheet 3, which is checked by the visible light reverse checking unit 43a. Hence, according to this embodiment, since each of the obverse surface and the reverse surface of the sheet 3 can be checked by two types of checks, printing quality can correctly be determined even on the sheet 3 whose both surfaces have undergone elaborate and complex printing.

The printing press 1 according to this embodiment includes the downstream-side obverse checking unit 42 (fifth checking unit) and the downstream-side reverse checking unit 44 (sixth checking unit). The downstream-side obverse checking unit 42 performs the ultraviolet light check (a check different from the visible light check and the infrared light check) for the obverse surface checked by the visible light obverse checking unit 41a. The downstream-side reverse checking unit 44 performs the ultraviolet light check (a check different from the visible light check and the infrared light check) for the reverse surface checked by the visible light reverse checking unit 43a. Hence, according to this embodiment, since three types of checks are performed for each of the obverse and reverse surfaces of the sheet 3, it is possible to provide a printing press having a higher checking accuracy.

The downstream-side obverse checking unit 42 according to this embodiment is an ultraviolet light checking unit that irradiates the obverse surface of the sheet 3 with ultraviolet light and performs the check based on reflected light, and the downstream-side reverse checking unit 44 is an ultraviolet light checking unit that irradiates the reverse surface of the sheet 3 with ultraviolet light and performs the check based on reflected light. These ultraviolet light checking units are provided on the downstream side in the sheet conveyance direction with respect to the visible light obverse checking unit 41a of the upstream-side obverse checking unit 41 and the visible light reverse checking unit 43a of the upstream-side reverse checking unit 43. For this reason, since the ultraviolet light checking units can be formed separately from the other checking units 41 and 43 on the upstream side, the check can be performed by the ultraviolet light checking units without making light other than ultraviolet light enter. In addition, the other checking units 41 and 43 can perform the check without making ultraviolet light excessively enter. Hence, according to this embodiment, it is possible to provide a printing press capable of executing each check at a high accuracy regardless of performing three types of checks.

In addition, the printing press 1 according to this embodiment can be constituted by diverting most parts of a normal sheet-fed offset printing press that is not used to print a paper money, securities, or the like. For this reason, according to this embodiment, it is possible to provide a printing press capable of printing a paper money, securities, or the like at low cost.

### Second Embodiment

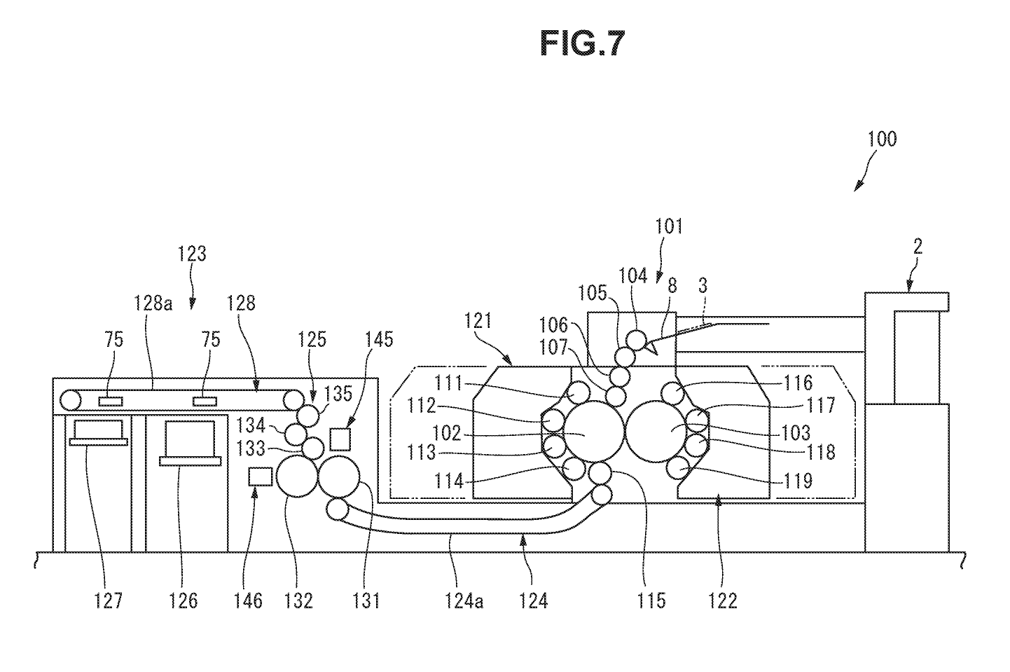

A printing press according to the present invention can be constructed as shown in FIGS. 7 to 9. The same reference numerals as in FIGS. 1 to 6 denote the same or similar members in these drawings, and a detailed description thereof will appropriately be omitted.

A printing press 100 shown in FIG. 7 is a four-color double-sided printing press including a printing unit 101 having a so-called satellite-type cylinder arrangement. At the center of the printing unit 101, a blanket impression cylinder 102 and a blanket cylinder 103 are arranged in the horizontal direction in contact with each other. The blanket impression cylinder 102 has a function of conveying a sheet 3 using a gripper device (not shown). The sheet 3 is fed from the side of a feeder board 8 to the blanket impression cylinder 102 by first to fourth transfer cylinders 104 to 107 arranged above the blanket impression cylinder 102.

First to fourth plate cylinders 111 to 114 and a fifth transfer cylinder 115 formed by a double-size cylinder are arranged around the blanket impression cylinder 102. Fifth to eighth plate cylinders 116 to 119 are arranged around the blanket cylinder 103.

The printing unit 101 includes first and second inking units 121 and 122, which sandwich, from both sides, the central portion formed by the blanket impression cylinder 102, the blanket cylinder 103, the first to fourth plate cylinders 111 to 114, the fifth transfer cylinder 115, and the fifth to eighth plate cylinders 116 to 119. The first inking unit 121 is used to supply ink and dampening water to the first to fourth plate cylinders 111 to 114. The first inking unit 121 is configured to be able to horizontally move with respect to the first to fourth plate cylinders 111 to 114 so as to approach or separate from them. The ink supplied from the first inking unit 121 to the first to fourth plate cylinders 111 to 114 is transferred to the blanket impression cylinder 102 and transferred to the obverse surface of the sheet 3 passing between the blanket impression cylinder 102 and the blanket cylinder 103. In this embodiment, the blanket impression cylinder 102, the first to fourth plate cylinders 111 to 114, the first inking unit 121, and the like constitute “first printing unit” of the present invention.

The second inking unit 122 is used to supply ink and dampening water to the fifth to eighth plate cylinders 116 to 119. The second inking unit 122 is configured to be able to horizontally move with respect to the fifth to eighth plate cylinders 116 to 119 so as to approach or separate from them. The ink supplied from the second inking unit 122 to the fifth to eighth plate cylinders 116 to 119 is transferred to the blanket cylinder 103 and transferred to the reverse surface of the sheet 3 passing between the blanket impression cylinder 102 and the blanket cylinder 103. In this embodiment, the blanket cylinder 103, the fifth to eighth plate cylinders 116 to 119, the second inking unit 122, the like constitute “second printing unit” of the present invention.

The fifth transfer cylinder 115 is configured to feed the sheet 3 after printing to a sheet delivery unit 123 to be described later. The sheet delivery unit 123 according to this embodiment includes a first chain-type conveyance device 124 whose upstream-side end is connected to the fifth transfer cylinder 115, a transfer cylinder group 125 connected to the downstream-side end of the first chain-type conveyance device 124, a second chain-type conveyance device 128 configured to feed the sheet 3 that has passed through the transfer cylinder group 125 to first and second delivery piles 126 and 127, and the like. The first and second chain-type conveyance devices 124 and 128 have the same arrangement as the chain-type conveyance device 74 described in the first embodiment, and include delivery chains 124a and 128a, respectively, and gripper bars and gripper devices (none are shown). A release device 75 configured to sort the sheets 3 of non-defective products and the sheets 3 of defective products is provided on the upper side of each of the first and second delivery piles 126 and 127. In this embodiment, the sheets 3 of non-defective products are stacked on the first delivery pile 126, and the sheets 3 of defective products are stacked on the second delivery pile 127.

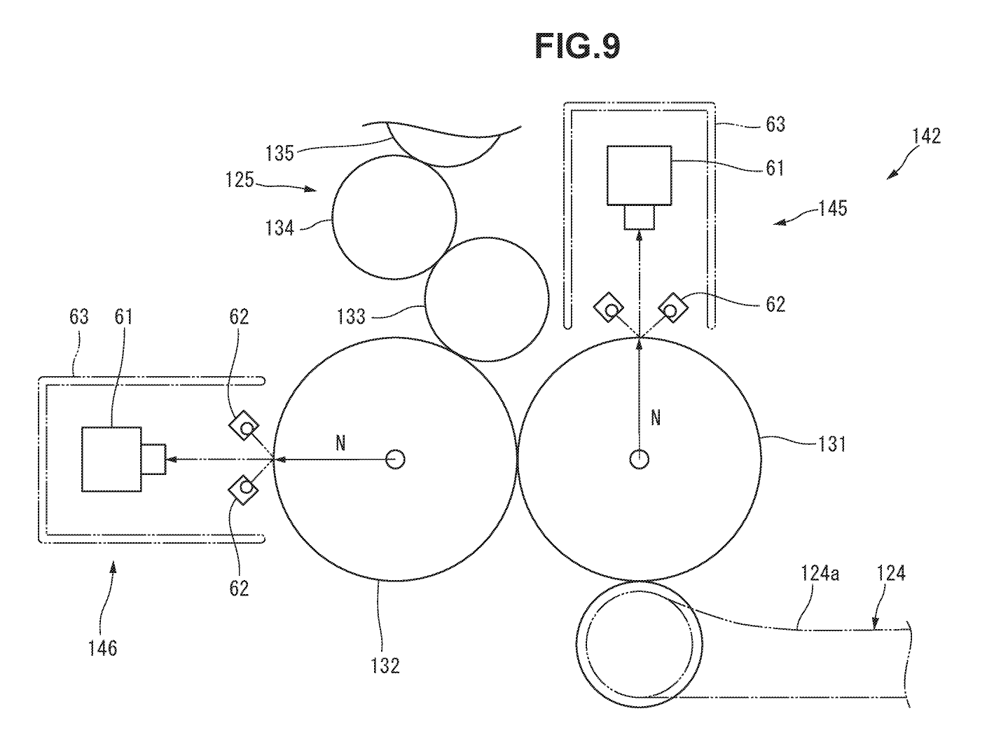

As shown in FIG. 9, the transfer cylinder group 125 is formed by first and second checking cylinders 131 and 132 arranged in the horizontal direction on the downstream-side end of the first chain-type conveyance device 124, and sixth to eighth transfer cylinders 133 to 135 arranged in the vertical direction above the second checking cylinder 132.

Each of the first and second checking cylinders 131 and 132 and the sixth to eighth transfer cylinders 133 to 135 includes a gripper device (not shown) and employs an arrangement for transferring and feeding the sheet 3. The outer diameter of each of the first and second checking cylinders 131 and 132 is twice as large as the outer diameter of each of the sixth to eighth transfer cylinders 133 to 135.

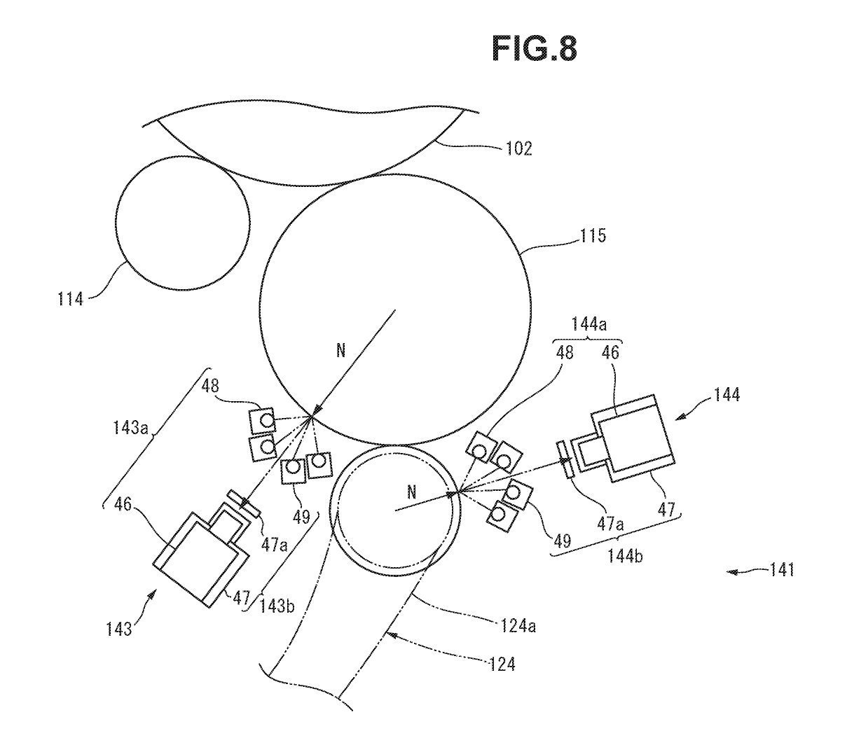

The printing press 100 according to this embodiment includes an upstream-side checking unit 141 (see FIG. 8) located near the lower portion of the printing unit 101, and a downstream-side checking unit 142 (see FIG. 9) located near the transfer cylinder group 125. The upstream-side checking unit 141 is formed by an upstream-side obverse checking unit 143 that directs to the fifth transfer cylinder 115, and an upstream-side reverse checking unit 144 that directs to the first chain-type conveyance device 124 near the downstream side in the sheet conveyance direction with respect to the fifth transfer cylinder 115. The upstream-side obverse checking unit 143 and the upstream-side reverse checking unit 144 have the same arrangements as the upstream-side obverse checking unit 41 and the upstream-side reverse checking unit 43 according to the first embodiment.

That is, the upstream-side obverse checking unit 143 includes a visible light obverse checking unit 143a formed by visible light checking cameras 46 and visible light illuminations 48, and an infrared light obverse checking unit 143b formed by an infrared light checking camera 47 and infrared light illuminations 49. In this embodiment, the visible light obverse checking unit 143a corresponds to “first checking unit” of the present invention, and the infrared light obverse checking unit 143b corresponds to “second checking unit” of the present invention.

In addition, the upstream-side reverse checking unit 144 includes a visible light reverse checking unit 144a formed by the visible light checking cameras 46 and the visible light illuminations 48, and an infrared light reverse checking unit 144b formed by the infrared light checking camera 47 and the infrared light illuminations 49. In this embodiment, the visible light reverse checking unit 144a corresponds to “third checking unit” of the present invention, and the infrared light reverse checking unit 144b corresponds to “fourth checking unit” of the present invention.

The visible light checking cameras 46 and the infrared light checking camera 47 of the upstream-side obverse checking unit 143 capture the obverse surface of the sheet 3 halfway through the conveyance of the sheet 3 by the fifth transfer cylinder 115 after printing. The visible light checking cameras 46 and the infrared light checking camera 47 of the upstream-side reverse checking unit 144 captures the reverse surface of the sheet 3 immediately after the sheet 3 is transferred from the fifth transfer cylinder 115 to the first chain-type conveyance device 124. Hence, in this embodiment as well, the visible light check is executed in a state without misregistration immediately after printing and before the sheet 3 is chain-conveyed.

As shown in FIG. 9, the downstream-side checking unit 142 is formed by a downstream-side obverse checking unit 145 that directs to the first checking cylinder 131, and a downstream-side reverse checking unit 146 that directs to the second checking cylinder 132. The downstream-side obverse checking unit 145 and the downstream-side reverse checking unit 146 have the same arrangements as the downstream-side obverse checking unit 42 and the downstream-side reverse checking unit 44 according to the first embodiment, and each include an ultraviolet light checking camera 61, ultraviolet light illuminations 62, and a shielding member 63. In this embodiment, the downstream-side obverse checking unit 145 corresponds to “fifth checking unit” of the present invention, and the downstream-side reverse checking unit 146 corresponds to “sixth checking unit” of the present invention.

The ultraviolet light checking camera 61 of the downstream-side obverse checking unit 145 captures the obverse surface of the sheet 3 halfway through the conveyance of the sheet 3 by the first checking cylinder 131. The ultraviolet light checking camera 61 of the downstream-side reverse checking unit 146 captures the reverse surface of the sheet 3 halfway through the conveyance of the sheet 3 by the second checking cylinder 132.

Even in the printing press 100 according to this embodiment, it is possible to perform a plurality of types of checks for both the obverse and reverse surfaces of the sheet 3, as in the printing press 1 according to the first embodiment. Hence, even when this embodiment is employed, the same effect as in the employment of the first embodiment can be obtained.

The downstream-side obverse checking unit 145 and the downstream-side reverse checking unit 146 according to this embodiment are located on the downstream side in the conveyance direction of the sheet 3 with respect to the upstream-side obverse checking unit 143 and the upstream-side reverse checking unit 144. For this reason, since the ultraviolet light checking units formed by the downstream-side obverse checking unit 145 and the downstream-side reverse checking unit 146 can be formed separately from the other checking units 143 and 144 on the upstream side, the check can be performed by the ultraviolet light checking units without making light other than ultraviolet light enter. In addition, the other checking units 143 and 144 can perform the check without making ultraviolet light excessively enter. Hence, in this embodiment as well, it is possible to provide a printing press capable of executing each check at a high accuracy regardless of performing three types of checks.

### Modification

In the above-described first and second embodiments, an example in which the visible light check, the infrared light check, and the ultraviolet light check are performed has been described. However, when performing a plurality of types of checks, an arrangement for performing two types of checks including the visible light check and the infrared light check may be employed, or an arrangement for performing two types of checks including the visible light check and the ultraviolet light check can also be employed.

In addition, the types of checks are not limited to the above-described three types and can appropriately be changed. Examples of other checks different from the three types of checks are a magnetic detection check and a watermark check. The magnetic detection check is executed when magnetized ink is used. To perform the magnetic detection check, for example, a transport cylinder made of a nonmagnetic material and a magnetic detection sensor located near the periphery of the transport cylinder are used, although not illustrated. That is, the magnetic detection check is performed by detecting the magnetism of a sheet conveyed by the transport cylinder by the magnetic detection sensor.

The watermark check is performed to determine the appropriateness of the position and quality of a watermark in a sheet. To do the watermark check, a transport cylinder made of a transparent material, a camera that captures the transport cylinder from the outside, an illumination device that irradiates the outer peripheral surface of the transport cylinder with light through its interior, and the like are used, although not illustrated. That is, the watermark check is performed by irradiating a sheet conveyed by the transport cylinder made of the transparent material with light from the inside of the transport cylinder, and capturing the light that has passed through the sheet by the camera. When considering the watermark check and other checks, the first to sixth checking units may check not only the printing quality of the sheet 3 but also the quality of the sheet 3 itself.

In the above-described first and second embodiments, the infrared light obverse checking units 41b and 143b and the infrared light reverse checking units 43b and 144b correspond to “second checking unit” and “fourth checking unit”, respectively, and the downstream-side obverse checking units 42 and 145 and the downstream-side reverse checking units 44 and 146 correspond to “fifth checking unit” and “sixth checking unit”, respectively. However, it can also be considered that the downstream-side obverse checking units 42 and 145 and the downstream-side reverse checking units 44 and 146 correspond to “second checking unit” and “fourth checking unit”, respectively, and the infrared light obverse checking units 41b and 143b and the infrared light reverse checking units 43b and 144b correspond to “fifth checking unit” and “sixth checking unit”, respectively.

In the above-described first and second embodiments, the arrangement for checking both surfaces of the sheet 3 has been described. However, a form for checking only the obverse surface or the reverse surface of the sheet 3 may be employed. In addition, the first checking unit, the second checking unit, and the fifth checking unit are checking units configured to check the obverse surface of the sheet 3, and the third checking unit, the fourth checking unit, and the sixth checking unit are checking units configured to check the reverse surface of the sheet 3. In contrast, the first checking unit, the second checking unit, and the fifth checking unit may be checking units configured to check the reverse surface of the sheet 3, and the third checking unit, the fourth checking unit, and the sixth checking unit may be checking units configured to check the obverse surface of the sheet 3.

### Explanation of the Reference Numerals and Signs

1, 100 . . . printing press, 3 . . . sheet, 5 . . . checking unit, 12 . . . obverse printing unit, 13 . . . reverse printing unit, 41, 143 . . . upstream-side obverse checking unit, 42, 145 . . . downstream-side obverse checking unit, 43, 144 . . . upstream-side reverse checking unit, 44, 146 . . . downstream-side reverse checking unit, 46 . . . visible light checking camera, 47 . . . infrared light checking camera, 48 . . . visible light illumination, 49 . . . infrared light illumination, 61 . . . ultraviolet light checking camera, 62 . . . ultraviolet light illumination, 102 . . . blanket impression cylinder, 103 . . . blanket cylinder, 111 . . . first plate cylinder, 112 . . . second plate cylinder, 113 . . . third plate cylinder, 114 . . . fourth plate cylinder, 116 . . . fifth plate cylinder, 117 . . . sixth plate cylinder, 118 . . . seventh plate cylinder, 119 . . . eighth plate cylinder, 121 . . . first inking unit, 122 . . . second inking unit.

1. A printing press comprising:
a first printing unit configured to perform printing on an obverse surface of a sheet;
a second printing unit configured to perform printing on a reverse surface of the sheet;
a first checking unit configured to irradiate one of the obverse surface and the reverse surface of the sheet with visible light and perform a check based on reflected light; and
a second checking unit configured to perform a check different from the check using the visible light for a surface, checked by the first checking unit, of the sheet.

2. The printing press according to claim 1, further comprising:
a third checking unit configured to irradiate, of the obverse surface and the reverse surface of the sheet, a surface that is not checked by the first checking unit with visible light and perform a check based on reflected light; and
a fourth checking unit configured to perform a check different from the check using the visible light for the surface, checked by the third checking unit, of the sheet.

3. The printing press according to claim 2, further comprising:
a fifth checking unit configured to perform a check different from the check using the visible light and the check performed by the second checking unit for, of the obverse surface and the reverse surface of the sheet, the surface checked by the first checking unit; and
a sixth checking unit configured to perform a check different from the check using the visible light and the check performed by the fourth checking unit for, of the obverse surface and the reverse surface of the sheet, the surface checked by the third checking unit.

4. The printing press according to claim 2, wherein the second checking unit is provided on a downstream side in a sheet conveyance direction with respect to the first checking unit and configured to irradiate the surface, checked by the first checking unit, of the sheet with ultraviolet light and perform the check based on reflected light, and
the fourth checking unit is provided on the downstream side in the sheet conveyance direction with respect to the third checking unit and configured to irradiate the surface, checked by the third checking unit, of the sheet with ultraviolet light and perform the check based on reflected light.

5. The printing press according to claim 4, further comprising:
a fifth checking unit configured to perform a check different from the checks using the visible light and the ultraviolet light for, of the obverse surface and the reverse surface of the sheet, the surface checked by the first checking unit; and
a sixth checking unit configured to perform a check different from the checks using the visible light and the ultraviolet light for, of the obverse surface and the reverse surface of the sheet, the surface checked by the third checking unit.
